(19) United States
(12) Patent Application Publication
(10) Pub. No.: US 2026/0269104 A1
(43) Pub. Date: Sep. 10, 2026

(54) HIGH-TEMPERATURE SUPERCONDUCTING WIRE AND SUPERCONDUCTING COIL

(71) Applicant: Mitsubishi Electric Corporation, Tokyo (JP)

(72) Inventors: Taisuke HATTORI, Tokyo (JP); Hideaki MIURA, Tokyo (JP); Shun TONOOKA, Tokyo (JP); Masayoshi OHYA, Hyogo (JP)

(73) Assignee: Mitsubishi Electric Corporation, Tokyo (JP)

(21) Appl. No.: 19/473,854

(22) PCT Filed: May 10, 2023
(86) PCT No.: PCT/JP2023/017512

§ 371 Date: Oct. 9, 2025

(51) Int. Cl. H01B 12/02; H01F 6/06

(52) U.S. Cl. CPC H01B 12/02; H01F 6/06

(57) ABSTRACT

A high-temperature superconducting wire includes: a substrate formed in a shape of a flat sheet; a superconducting laminate member stacked on the substrate and having an intermediate layer and a superconducting layer; a stabilization member formed from a metal plating and disposed to be superposed on the superconducting laminate member; an insulation member layer subjected to releasing treatment with respect to a resin and covering an outer periphery of a laminate structure in which the substrate, the superconducting laminate member, and the stabilization member-are stacked to be integrated; and a tape-shaped fixation member wound so as to cover an outer periphery of the insulation member layer and fixing the insulation member layer to the superconducting laminate member.

### TECHNICAL FIELD

The present disclosure relates to a high-temperature superconducting wire and a superconducting coil.

### BACKGROUND ART

A conventional high-temperature superconducting wire or a superconducting coil formed of the high-temperature superconducting wire includes: a superconducting laminate having a tape-shaped base material that forms a wire material of the superconducting wire, and an intermediate layer, an oxide superconducting layer, and a metal stabilization layer which are stacked on the base material; and an insulation covering layer covering an outer surface of the superconducting laminate, the insulation covering layer having an outer surface and an inner surface one of which is entirely coated with a coating layer formed from a fluorine resin. The insulation covering layer is formed by winding insulation tape coated with the coating layer around the superconducting laminate. Furthermore, at least one such insulation tape is wound so as to cover the entire outer surface of the superconducting laminate.

Explanations regarding this are as follows. The high-temperature superconducting wire has the shape of wide tape and is susceptible to a stress (peeling stress) applied in a direction perpendicular to the width direction thereof. Considering this, tape subjected to releasing treatment with respect to a resin is wound. Consequently, even when a resin has adhered on the superconducting wire material through entry, the superconducting wire material is protected while being fixed such that the resin having adhered is easily peeled from the superconducting wire material (see, for example, Patent Document 1).

A basic structure of the high-temperature superconducting wire configured as described above will be described below in detail with reference to FIG. 1 (see, for example, Non-Patent Document 1).

As shown in FIG. 1, the high-temperature superconducting wire has the shape of a rectangular flat sheet as a whole and has a thickness Lt of 0.17 mm which is sufficiently smaller than a width Lw thereof which is, for example, 4 mm.

In addition, in FIG. 1, a superconducting laminate member 2 is stacked on a base material 1 (hereinafter, also referred to as “substrate 1”), and outer peripheries of the substrate 1 and the superconducting laminate member 2 are covered by a stabilization member formed from a copper plating material or the like. The stabilization member is further covered by insulation tapes forming two types of (two) insulation covering layers with an insulation member layer 3 between the stabilization member and the insulation tapes. The insulation tapes forming the two types of (two) insulation covering layers are each formed from a polyimide (these insulation tapes are also referred to as “fixation member 4” and “outer fixation member 5”; the same applies below), and at least one of the insulation tapes is coated with a coating layer formed from a fluorine resin.

The purpose of this is to prevent peeling which might occur because the high-temperature superconducting wire has the shape of wide tape and is susceptible to a stress (peeling stress) applied in a y direction (a normal direction to a surface of the above shape of the rectangular flat sheet) perpendicular to an x direction in FIG. 1 which is a longitudinal direction of the wire material (hereinafter, also referred to as “direction parallel to the wire material”), as described above. The purpose of coating at least one of the insulation tapes with a fluorine resin is to, even when a resin as an adhesive for fixing the insulation tape to the high-temperature superconducting wire has adhered on the superconducting wire material, allow the resin having adhered to be easily peeled from the superconducting wire material (the reason for having to allow this peeling is because adhesion of such a resin leads to degradation of the superconducting wire material).

Also, a high-temperature superconducting coil in which a conventional oxide high-temperature superconducting wire is used is as follows (see, for example, Patent Document 2). That is, the high-temperature superconducting coil includes a pancake coil in which a tape-shaped high-temperature superconducting wire material including a metal substrate having a surface on which an oxide superconducting layer has been formed is used, the pancake coil having been formed in the shape of a pancake having a space through which the center thereof in an axial direction is penetrated, by winding the high-temperature superconducting wire material. In this pancake coil, at least a part of winding side surface portions forming a pair of end surfaces in the axial direction is coated with a resin layer. This configuration allows production of a coil in which the high-temperature superconducting wire material and tape are co-wound so that a peeling stress applied to the superconducting layer is mitigated and degradation does not easily occur.

### CITATION LIST

### Patent Document

Patent Document 1: International Publication No. WO2013/187353

Patent Document 2: Japanese Laid-Open Patent Publication No. 2010-267887

### Non-Patent Document

Non-Patent Document 1: M. Oya et al., “Design and Manufacture of Half-Size 3-T High-Temperature Superconducting Magnet for MRI”, IEEE Transactions on Applied Superconductivity, Vol. 28, No. 3, April, 2018

### SUMMARY OF THE INVENTION

### Problem to be Solved by the Invention

In general, in such a high-temperature superconducting wire or a high-temperature superconducting coil in which the high-temperature superconducting wire is used, an insulation layer coated with fluorine is wound around a wide wire material. Consequently, even when a resin used for forming and fixing a coil has adhered on a superconducting layer, the resin having adhered is easily peeled from the superconducting layer. In this case, lap winding in which covering tape is wound while being partially superposed is employed in order to avoid entry of the resin from a gap during the winding.

Also, in the above Patent Document 2, a coil obtained by co-winding insulation tape around the superconducting wire material is fixed by the resin layer having a heat transmission member serving also as a heat transmission path, whereby the shape of the coil is retained.

However, there is a disadvantage that the lap winding results in elongation of the distance between the superconducting wire materials and decrease in coil current density. In addition, a problem arises in that the lap winding might result in unevenness in the distance between the wire materials and might become a new cause of a peeling stress, for example. In addition, in the insulation tape co-winding method, the resin layer is required to have the heat transmission member which is not always necessary in the lap winding.

The present disclosure has been made to solve the above problems, and an object of the present disclosure is to provide: a superconducting wire that can shorten the distance between superconducting wire materials, ensure a necessary coil current density, and also achieve evenness in the distance between the superconducting wire materials so that occurrence of a new cause of a peeling stress can be prevented; and a superconducting coil formed of the superconducting wire.

### Means to Solve the Problem

A high-temperature superconducting wire according to the present disclosure includes:
a substrate formed in a shape of a flat sheet;
a superconducting laminate member which is disposed on the substrate and in which a superconducting layer is stacked with an intermediate layer therebetween;
a stabilization member formed from a metal plating and disposed to be superposed on the superconducting laminate member;
an insulation member layer subjected to releasing treatment with respect to a resin and covering an outer periphery of a laminate structure in which the substrate, the superconducting laminate member, and the stabilization member are stacked to be integrated; and
a tape-shaped fixation member wound so as to cover an outer periphery of the insulation member layer and fixing the insulation member layer to the superconducting laminate member.

### Effect of the Invention

With the high-temperature superconducting wire according to the present disclosure, it is possible to provide: a superconducting wire that can shorten the distance between superconducting wire materials, ensure a necessary coil current density, and also achieve evenness in the distance between the superconducting wire materials so that occurrence of a new cause of a peeling stress can be prevented; and a superconducting coil formed of the Superconducting wire.

### BRIEF DESCRIPTION OF THE DRAWINGS

FIG. 1 is a perspective view showing a structure example of a high-temperature superconducting wire for explaining the problems addressed in the present disclosure.

FIG. 2 is a perspective view for explaining a structure example of a high-temperature superconducting wire according to embodiment 1.

FIG. 3 is a top view for explaining the structure example of the high-temperature superconducting wire according to embodiment 1.

FIG. 4 is a diagram for explaining a laminate structure of a superconducting layer of the high-temperature superconducting wire according to embodiment 1.

FIG. 5 is a perspective view showing an example of a high-temperature superconducting wire obtained through gap winding according to embodiment 1.

FIG. 6 is a perspective view showing another example of the high-temperature superconducting wire obtained through gap winding according to embodiment 1.

FIG. 7 is a perspective view for explaining a superconducting coil formed of the high-temperature superconducting wires according to embodiment 1.

FIG. 8 is a top view for explaining an example of a partial structure of the superconducting coil according to embodiment 1.

FIG. 9 shows a comparative example for comparison to the partial structure of the superconducting coil in FIG. 8.

FIG. 10 is a top view for explaining another example of the partial structure of the superconducting coil according to embodiment 1.

FIG. 11 is a top view for explaining still another example of the partial structure of the superconducting coil according to embodiment 1.

FIG. 12 is a perspective view for explaining one structure example of a high-temperature superconducting wire according to embodiment 2.

FIG. 13 is a top view for explaining the one structure example of the high-temperature superconducting wire according to embodiment 2.

FIG. 14 is a top view for explaining another structure example of the high-temperature superconducting wire according to embodiment 2.

### DESCRIPTION OF EMBODIMENTS

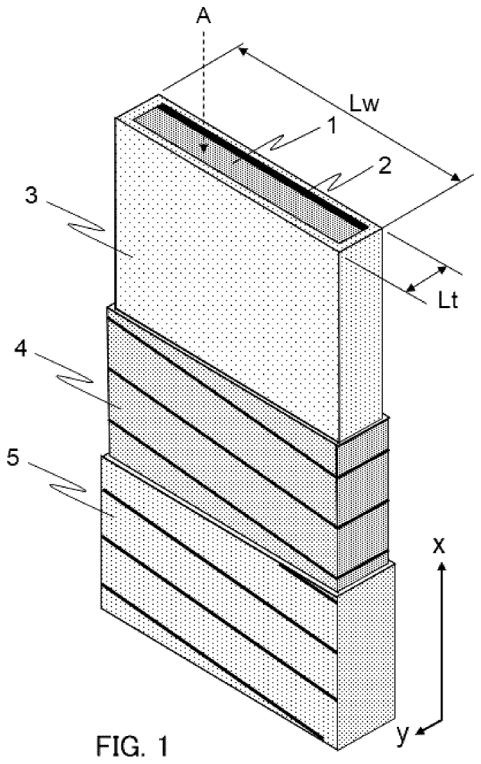

A high-temperature superconducting wire and a superconducting coil according to embodiment 1 of the present disclosure will be described below in detail with reference to the drawings through comparison to the above features described with reference to FIG. 1.

### Embodiment 1

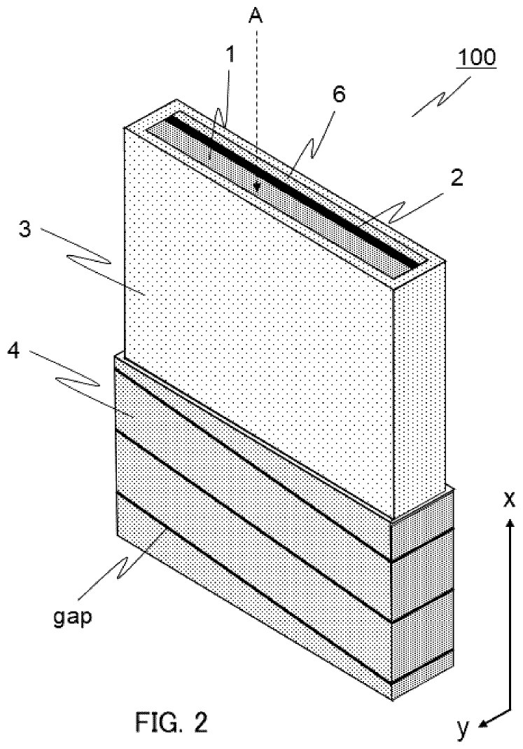

FIG. 2 is a diagram for explaining an example of the configuration of a high-temperature superconducting wire 100 according to embodiment 1. The high-temperature superconducting wire 100 according to embodiment 1 will be described below in detail with reference to FIG. 2. In the high-temperature superconducting wire 100 according to embodiment 1, a fixation member 4 covering an outer periphery of an insulation member layer 3 which is a rectangular tubular member is one type of (one) fixation member and does not have to be coated with a fluorine resin. In other words, in the present embodiment, the number of fixation members may be one, and it is unnecessary to use both two types of fixation members (the fixation member 4 and the outer fixation member 5) described above.

As shown in FIG. 2, the high-temperature superconducting wire 100 according to embodiment 1 has the shape of a flat sheet as a whole and includes a rectangular stabilization member 6 (formed from, for example, a copper plating) having a tubular portion. In (a space of) the tubular portion, a substrate 1 having the shape of a flat sheet, a superconducting laminate member 2 which is disposed on the substrate 1 and in which a superconducting layer is stacked with a superconducting layer and an intermediate layer therebetween, and an insulation member layer 3 subjected to releasing treatment with respect to a resin through fluorine treatment are stacked to be integrated (hereinafter, the resultant laminate is also referred to as “laminate structure”).

Furthermore, in order to fix the stabilization member 6 to the above superconducting laminate member 2, a tape-shaped fixation member 4 such as insulation tape (formed from, for example, a polyimide) is wound so as to cover the outer periphery of the above insulation member layer 3 with a predetermined size of gap (see FIG. 2) interposed (hereinafter, this manner of winding with a gap interposed is simply referred to as “gap winding”). Here, the gap is formed in the width direction of the insulation tape, and the size of the gap is set to, for example, zero (i.e., no gap) or a minute size that is about 5% of the width of the insulation tape.

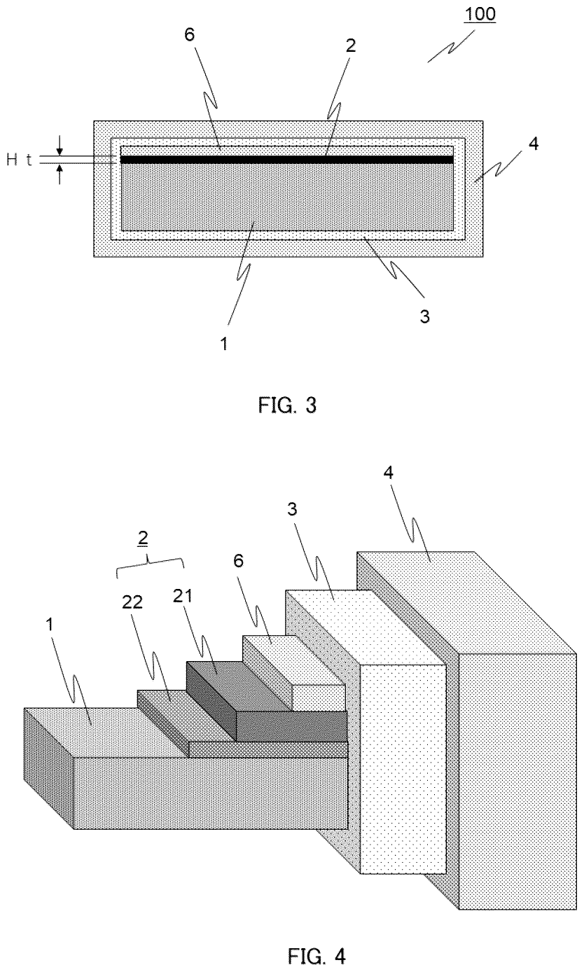

Next, FIG. 3 is a top view of the high-temperature superconducting wire 100 according to embodiment 1. That is, FIG. 3 is a view of the above high-temperature superconducting wire 100 according to embodiment 1 as seen from above (a view of the high-temperature superconducting wire 100 as seen in a direction indicated by an arrow A in FIG. 2).

In FIG. 3, the insulation member layer 3 (having a thickness of, for example, 20 μm) which is hollow and which has a rectangular shape has a hollow portion in which the substrate 1 (having a thickness of, for example, 75 μm) formed from, for example, an Ni alloy, the superconducting laminate member 2, and the stabilization member 6 are disposed in this order from the lower side.

By configuring the high-temperature superconducting wire 100 as described above, a stress (peeling stress) applied to the insulation tape in a y direction in FIG. 2 (a normal direction to a rectangle surface (denoted by a reference character 3) of the high-temperature superconducting wire) perpendicular to an x direction which is a longitudinal direction of the high-temperature superconducting wire can be suppressed, and hence, the insulation member layer 3 can be prevented from being peeled from the superconducting laminate member 2.

In addition, the insulation member layer 3 has been subjected to releasing treatment. Thus, even when an adhesive used to fix the insulation tape has adhered on the superconducting laminate member 2, a release effect can prevent the adhesive from being kept in a state of adhering on the superconducting laminate member (since the adhesive is peeled owing to the release effect). Consequently, the performance deterioration of the superconducting layer due to entry of such an adhesive can be prevented.

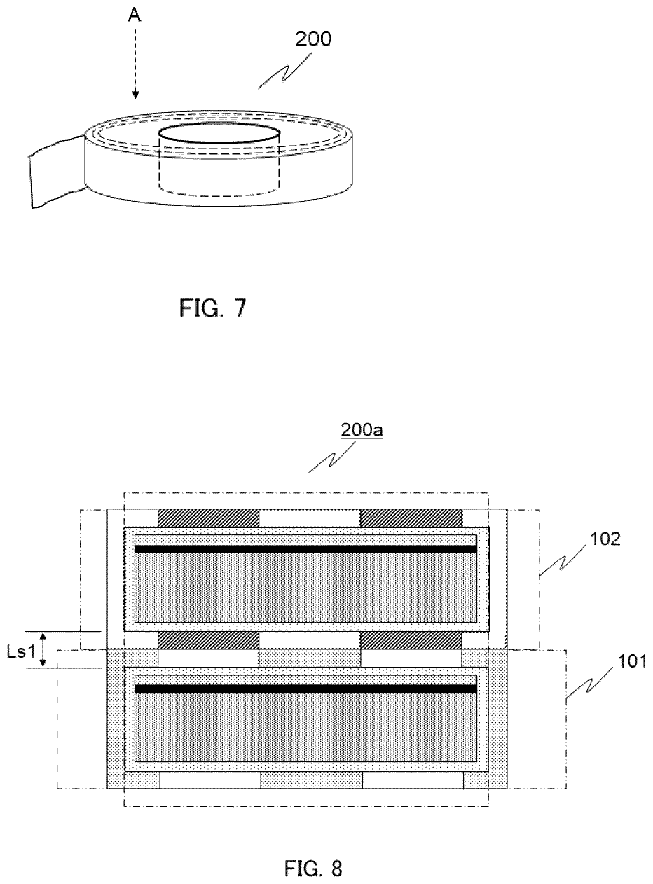

Also, the above high-temperature superconducting wire 100 is concentrically wound in a superposed manner so as to be formed into a toroidal shape (having an outer diameter of, for example, several hundreds of millimeters) as seen from above (see a direction indicated by an arrow A in FIG. 7), whereby, for example, a pancake-shaped superconducting coil 200 having excellent superconducting performance can be produced (see FIG. 7).

In this case, the insulation tape covering an outer periphery of the high-temperature superconducting wire 100 has been wound and formed so as not to be superposed between windings adjacent to each other (this structure will be described later in detail).

Next, a detailed structure of the superconducting laminate member 2 of the high-temperature superconducting wire 100 according to embodiment 1 will be described with reference to FIG. 4. Here, FIG. 4 is a three-dimensional schematic diagram for explaining the detailed structure of the superconducting laminate member 2.

As shown in FIG. 4, the superconducting laminate member 2 is stacked so as to be sandwiched between the substrate 1 and the stabilization member 6 and is composed of an intermediate layer 22 stacked on the substrate 1 side and a superconducting layer 21 stacked on the stabilization member 6 side. As described above, the laminate structure in which the substrate 1, the superconducting laminate member 2, and the stabilization member 6 are stacked has a periphery covered by the insulation member layer 3 having the shape of a rectangular tube, and furthermore, this insulation member layer 3 has an outer periphery covered by the fixation member 4 having the shape of a rectangular tube. As the superconducting layer 21, for example, an oxide superconducting member is used.

In view of this, advantageous effects exhibited when the above high-temperature superconducting wire 100 is used as a wire material of a superconducting coil will be described as follows. In the high-temperature superconducting wire 100, the insulation member layer 3 has been subjected to fluorine treatment, and the stabilization member 6 is disposed along the superconducting laminate member 2 parallelly without being wound around the superconducting laminate member 2. Consequently, an adhesive resin used for forming and fixing a coil does not reach the superconducting layer 21 and does not come into direct contact with the superconducting layer 21.

Therefore, the tape-shaped fixation member 4 (here, for example, insulation tape) disposed so as to cover the outer periphery of the insulation member layer 3 can be obtained through the gap winding. Thus, as described later in detail, the thickness of the fixation member as an insulator covering the outer periphery of the high-temperature superconducting wire 100 can be made substantially small. Therefore, the distance between the superconducting wire materials (superconducting layers) does not become long. As a result, a necessary current density can be ensured in a superconducting coil in which the above high-temperature superconducting wire 100 is used.

Meanwhile, in conventional art, lap winding in which covering tape is wound while being partially superposed needs to be performed as described in relation to the above problems. Thus, in the conventional art, the distance between the superconducting wire materials (superconducting layers) becomes long, resulting in decrease in the coil current density in the superconducting coil. In addition, in the lap winding, the distance between the superconducting wire materials (superconducting layers) is uneven, and thus this unevenness might become a new cause of occurrence of a peeling stress.

Next, in view of this, specific examples of a high-temperature superconducting wire obtained through the above gap winding will be described below in detail with reference to the drawings.

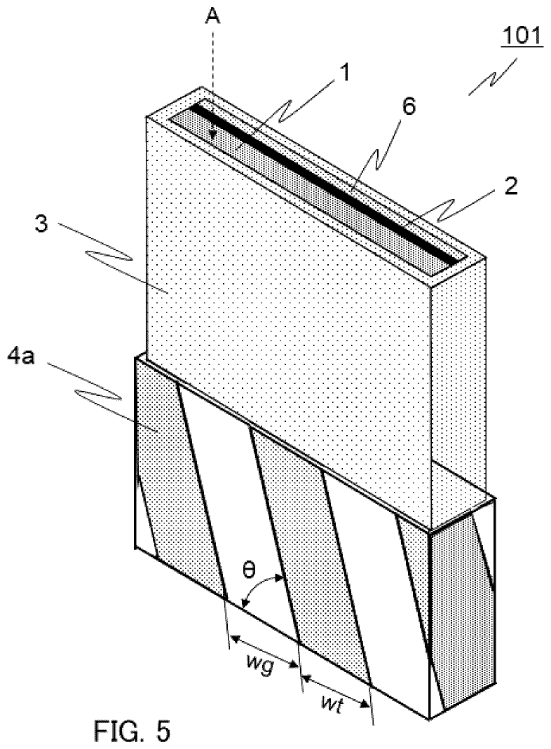

FIG. 5 is a perspective view showing a structure of a high-temperature superconducting wire 101 as an example of the high-temperature superconducting wire obtained through the gap winding according to embodiment 1. Here, the high-temperature superconducting wire 101 will be described below with focus placed on the differences from the above high-temperature superconducting wire 100.

The high-temperature superconducting wire 101 has substantially the same structure as that of the high-temperature superconducting wire 100 but differs therefrom in terms of the manner of winding the tape-shaped fixation member disposed on the outer periphery of the insulation member layer 3 (a state where the fixation member is wound). Specifically, the high-temperature superconducting wire 101 includes a fixation member 4a which is the same as the fixation member 4 of the high-temperature superconducting wire 100 in that the fixation member 4a has been subjected to the gap winding with a gap interposed (the size of the gap is denoted by wg; see FIG. 5) and which differs from the fixation member 4 in that the fixation member 4a is wound around the outer periphery of the insulation member layer 3 with the gap having a size not smaller than a width wt of the fixation member 4a, i.e., with the relationship wg≥wt being satisfied. The size of the gap is a size in the width direction of the fixation member. Also, in this case, an angle θ shown in FIG. 5 is defined as an angle formed between a line connecting a plurality of bases on which the fixation member is wound and the longitudinal direction of one wound portion of the fixation member, and has a value between 60 degrees and 90 degrees, for example.

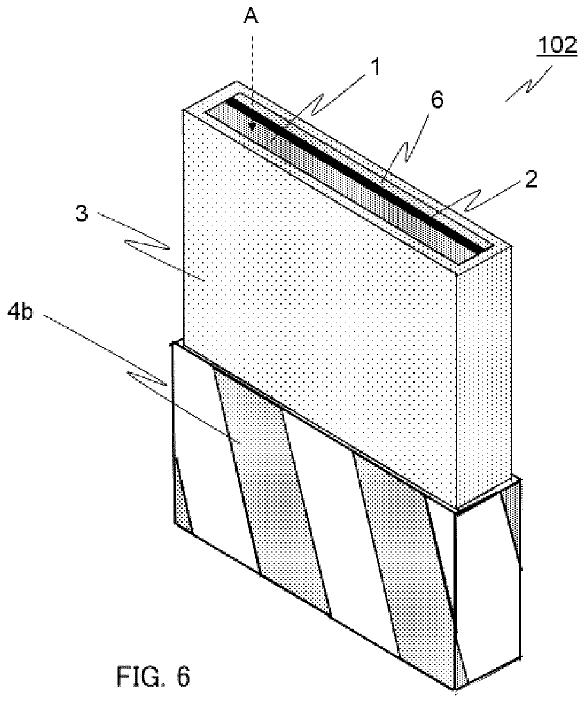

FIG. 6 described next is a perspective view showing a structure of a high-temperature superconducting wire 102 as another example of the high-temperature superconducting wire obtained through the gap winding according to embodiment 1. Similar to the high-temperature superconducting wire 101, the high-temperature superconducting wire 102 also has substantially the same structure as that of the high-temperature superconducting wire 100 but differs therefrom in terms of the manner of winding a tape-shaped fixation member 4b disposed on the outer periphery of the insulation member layer 3 (a state where the fixation member 4b is wound).

Specifically, the high-temperature superconducting wire 102 differs from the high-temperature superconducting wire 101 in that the (left-right) arrangement relationship between the winding position and the gap position of the tape-shaped fixation member 4b is the reverse of the (left-right) arrangement relationship in the above high-temperature superconducting wire 101.

In a case where the high-temperature superconducting wire 101 and the high-temperature superconducting wire 102 are combined to be used as one set and are assembled into a superconducting coil 200a by being concentrically wound with the one set being regarded as a unit (see, for example, FIG. 7), a top view corresponding to the one set of high-temperature superconducting wires of the superconducting coil 200a is as shown in FIG. 8.

In FIG. 8, a lower-side portion enclosed by an alternate long and two short dashes line is a portion corresponding to the high-temperature superconducting wire 101, and an upper-side portion enclosed by an alternate long and two short dashes line is a portion corresponding to the high-temperature superconducting wire 102.

Here, Ls1 in the drawing represents the distance between portions at which the fixation members of the two high-temperature superconducting wires 101 and 102 adjacent to each other are opposed to each other.

In this case, the gap wg of each of the fixation members and the width wt of the fixation member are in a relationship wt>wg.

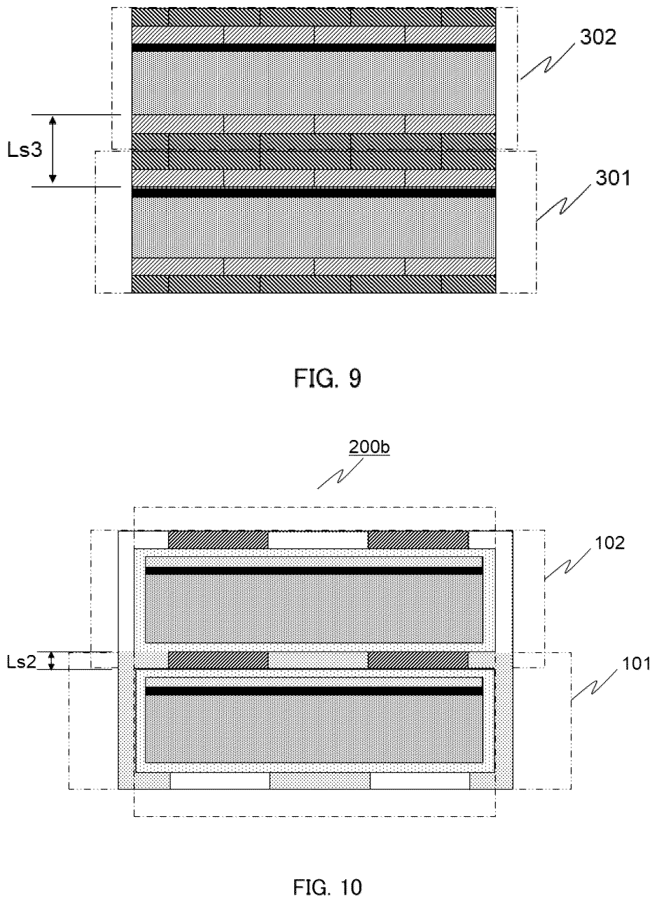

For comparison to the above superconducting coil 200a, a (similar) top view corresponding to one set of high-temperature superconducting wires (see FIG. 1) in the conventional art, i.e., one set of a high-temperature superconducting wire 301 and a high-temperature superconducting wire 302, is as shown in FIG. 9.

In this case, in each of both the high-temperature superconducting wire 301 and the high-temperature superconducting wire 302, two types of insulation tapes are wound around the corresponding stabilization member, and thus the distance between portions at which the insulation tapes of the two high-temperature superconducting wires 301 and 302 adjacent to each other are opposed to each other is represented by Ls3 shown in the drawing.

Here, if the thickness of each of the fixation members of the high-temperature superconducting wires 101 and 102 and the thickness of each of the fixation members of the high-temperature superconducting wires 301 and 302 are assumed to be equal to each other, the magnitude of Ls3 is found to be 2 times the magnitude of the above Ls1.

Therefore, the distance between the superconducting layers of the high-temperature superconducting wire 101 and the high-temperature superconducting wire 102 can be made shorter than the distance between the superconducting layers of the high-temperature superconducting wire 301 and the high-temperature superconducting wire 302 by Ls1 which is the difference between Ls3 and Ls1. As a result, in the superconducting coil in which the above high-temperature superconducting wires 101 and 102 are used as a set, a necessary current density is found to be more easily obtainable than in the case of using the high-temperature superconducting wire 301 and the high-temperature superconducting wire 302.

Considering this, the case shown in FIG. 8 is further developed. For example, a case is conceivable where the gap wg of the fixation member and the width wt of the fixation member in each of both the high-temperature superconducting wire 101 and the high-temperature superconducting wire 102 are equal to each other. In this case, when the high-temperature superconducting wire 101 and the high-temperature superconducting wire 102 are combined to be used as one set and are assembled into a superconducting coil 200b by being concentrically wound with the one set being regarded as a unit, a top view corresponding to the one set of high-temperature superconducting wires of the superconducting coil 200b is found to be as shown in FIG. 10.

In this case, the distance between portions at which the fixation members of the two high-temperature superconducting wires 101 and 102 adjacent to each other are opposed to each other is Ls2 (see FIG. 10). In this case, Ls2 is equal to the size, i.e., thickness, of each of the fixation members. Thus, the distance between the superconducting layers in the superconducting coil 200b can be made even shorter than the distance between the superconducting layers in the superconducting coil 200a. As a result, a necessary current density is found to be even more easily obtainable than in the case shown in FIG. 8.

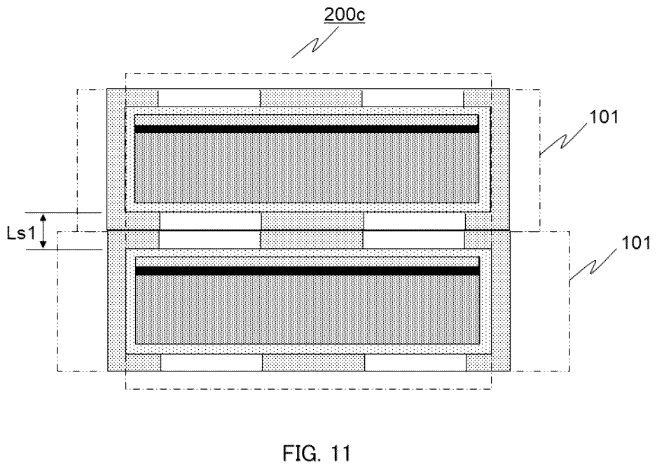

A superconducting coil in which the two different high-temperature superconducting wires 101 and 102 are used in combination as high-temperature superconducting wires adjacent to each other has been described with reference to FIG. 8. However, the superconducting coil is not limited thereto and may be a superconducting coil 200c (see FIG. 11) in which two high-temperature superconducting wires 101 of one type are used in combination. In the superconducting coil 200c as well, the distance between portions at which the fixation members of the two high-temperature superconducting wires 101 adjacent to each other are opposed to each other is Ls1 in the same manner as in FIG. 8. Consequently, the superconducting coil 200c exhibits the same advantageous effects as those of the superconducting coil 200a in FIG. 8.

In addition, FIG. 10 corresponds to a case where the gap wg of the fixation member and the width wt of the fixation member are equal to each other. However, without limitation thereto, the fixation member (for example, insulation tape) may be wound with a gap interposed, the gap being not smaller than the width wt of the fixation member (in this case, wg>wt is satisfied), and the winding positions of the fixation members may be adjusted so as to prevent the fixation members from being superposed on each other when a superconducting coil is formed. Consequently, the distance between the superconducting layers when a superconducting coil is formed, can be shortened. In other words, the density of the superconducting layer can be increased. Thus, such a superconducting coil exhibits the same advantageous effects as those of the superconducting coil described with reference to FIG. 8.

Under a condition that the insulation member layer subjected to fluorine treatment is fixed, a larger gap of the insulation tape covering the outer periphery is better, and the proportion of the gap is preferably 80% or higher. Examples of a fixation element satisfying this condition can include a threadlike member that is sufficiently thinner as compared to, for example, a thickness Ht (see FIG. 3) of the superconducting laminate member. Specifically, for example, 10Td≤Ht where Td represents the maximum diameter of the threadlike member is satisfied.

In order to improve the degree of evenness among the positions of wire materials in the superconducting coil, at portions at which the thicknesses are desired to be increased, the fixation members (insulation tapes) of the wire materials adjacent to each other can be disposed to be superposed, and the distance between the superconducting laminate members can be finely adjusted (in the case of using the superconducting coil 200c; see FIG. 11).

### Embodiment 2

A high-temperature superconducting wire 103 according to embodiment 2 will be described below in detail with reference to the drawings with focus placed on the differences from the high-temperature superconducting wire according to embodiment 1.

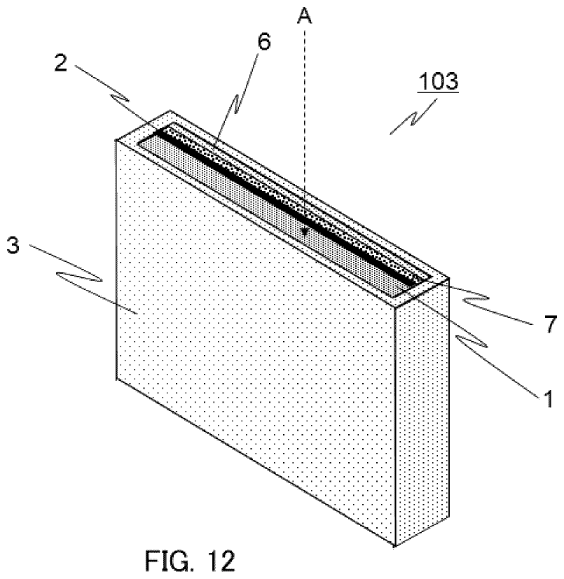

FIG. 12 is a perspective view for explaining the high-temperature superconducting wire 103 according to embodiment 2.

As shown in FIG. 12, the high-temperature superconducting wire 103 according to embodiment 2 most prominently differs from the high-temperature superconducting wire according to embodiment 1 in that the high-temperature superconducting wire 103 does not include the fixation member implemented by insulation tape provided to the high-temperature superconducting wire according to embodiment 1. In the present embodiment, the stabilization member 6 is parallelly fixed to the superconducting laminate member 2 through adhesion in advance. Thus, insulation treatment can be assuredly performed on the high-temperature superconducting wire. In other words, this case is the same as a case where the proportion of the gap is set to 100% in the above gap winding.

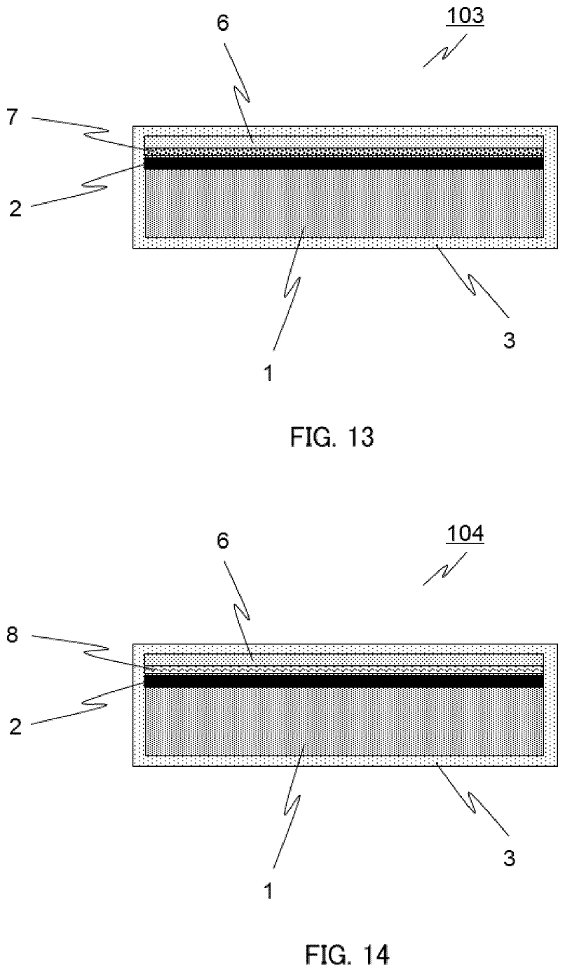

A difference other than the above difference is that, inside the insulation member layer 3 having the shape of a rectangular tube in the high-temperature superconducting wire 103 according to embodiment 2, an adhesive 7 (adhesive layer 7) for adhering the superconducting laminate member 2 and the stabilization member 6 to each other is provided in addition to the superconducting laminate member 2 and the stabilization member 6 (see FIG. 13). A superconducting coil formed by winding the high-temperature superconducting wire 103 according to embodiment 2 also exhibits the same advantageous effects as those of the superconducting coil according to embodiment 1.

An outer portion of the insulation member layer has been subjected to releasing treatment. The purpose of the releasing treatment is to prevent the insulation member layer itself from adhering on an adjacent superconducting wire material when a coil is formed.

Also, in a high-temperature superconducting wire 104 according to embodiment 2, the stabilization member 6 has a surface on a side opposed to the superconducting laminate member 2, the surface being provided with insulation tape 8 having tackiness (also referred to as “tacky insulation tape 8”) instead of the above adhesive (see FIG. 14). In the case of forming a superconducting coil by winding the high-temperature superconducting wire 104 as well, the same advantageous effects as those in the case of forming a superconducting coil by winding the high-temperature superconducting wire 103 are exhibited.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the specification of the present disclosure.

For example, a case where a fixation member is used for the high-temperature superconducting wire has been described above, but, without limitation thereto, the insulation member layer 3 may be fixed to the superconducting layer in advance in order to assuredly perform insulation treatment on the high-temperature superconducting wire. This alternative may be considered to correspond to a case where the proportion of the gap between windings of the insulation tape in the above description is set to 100%.

### DESCRIPTION OF THE REFERENCE CHARACTERS

1 substrate
2 superconducting laminate member
3 insulation member layer
4, 4a, 4b fixation member (insulation tape)
5 outer fixation member
6 stabilization member (copper plating member)
7 adhesive
8 insulation tape having tackiness (tacky insulation tape)
21 superconducting layer
22 intermediate layer
100, 101, 102, 103, 104 high-temperature superconducting wire
200 superconducting coil
200a, 200b, 200c superconducting coil (portion)

1. A high-temperature superconducting wire comprising:
a substrate formed in a shape of a flat sheet;
a superconducting laminate member which is disposed on the substrate and in which a superconducting layer is stacked with an intermediate layer therebetween;
a stabilization member formed from a metal plating and disposed to be parallel to the superconducting laminate member;
an insulation member layer subjected to releasing treatment with respect to a resin and covering an outer periphery of a laminate structure in which the substrate, the superconducting laminate member, and the stabilization member are stacked to be integrated; and
a tape-shaped fixation member wound through gap winding so as to cover an outer periphery of the insulation member layer and fixing the insulation member layer to the superconducting laminate member.

2. The high-temperature superconducting wire according to claim 1, wherein the fixation member is insulation tape and is wound with a gap interposed in a width direction of the insulation tape.

3. The high-temperature superconducting wire according to claim 1, wherein the fixation member is insulation tape and is wound with a gap interposed in a width direction of the insulation tape, the gap being not smaller than a width of the insulation tape.

4. The high-temperature superconducting wire according to claim 1, wherein the fixation member is a threadlike member that is thinner as compared to a thickness of the superconducting laminate member.

5. The high-temperature superconducting wire according to claim 1, wherein
the insulation member layer has been subjected to the releasing treatment through fluorine treatment, and
the stabilization member is disposed on a side opposite to the substrate to be parallel to the superconducting laminate member.

6. A high-temperature superconducting wire comprising:
a substrate formed in a shape of a flat sheet;
a superconducting laminate member which is disposed on the substrate and in which a superconducting layer is stacked with an intermediate layer therebetween;
a stabilization member disposed to be parallel to the superconducting laminate member and adhered to the superconducting laminate member by an adhesive; and
an insulation member layer covering an outer periphery of a laminate structure in which the substrate, the superconducting laminate member, and the stabilization member are stacked to be integrated, the insulation member layer having an outer portion subjected to releasing treatment so as to prevent the insulation member layer from adhering on an adjacent superconducting wire material when a coil is formed.

7. (canceled)

8. (canceled)

9. The high-temperature superconducting wire according to claim 1, wherein
the superconducting layer is formed of an oxide superconducting member, and
the stabilization member is formed from a copper plating.

10. A superconducting coil formed of the high-temperature superconducting wire according to claim 1, wherein insulation tape covering an outer periphery of the high-temperature superconducting wire has been wound and formed so as not to be superposed between the high-temperature superconducting wires adjacent to each other.

11. A superconducting coil comprising the high-temperature superconducting wire according to claim 1 having been wound to form the superconducting coil.

12. A superconducting coil comprising the high-temperature superconducting wire according to claim 9 having been wound to form the superconducting coil.

13. A superconducting coil comprising the high-temperature superconducting wire according to claim 10 having been wound to form the superconducting coil.

14. The high-temperature superconducting wire according to claim 2, wherein
the insulation member layer has been subjected to the releasing treatment through fluorine treatment, and
the stabilization member is disposed on a side opposite to the substrate to be parallel to the superconducting laminate member.

15. The high-temperature superconducting wire according to claim 3, wherein
the insulation member layer has been subjected to the releasing treatment through fluorine treatment, and
the stabilization member is disposed on a side opposite to the substrate to be parallel to the superconducting laminate member.

16. The high-temperature superconducting wire according to claim 4, wherein
the insulation member layer has been subjected to the releasing treatment through fluorine treatment, and
the stabilization member is disposed on a side opposite to the substrate to be parallel to the superconducting laminate member.

17. The high-temperature superconducting wire according to claim 14, wherein
the superconducting layer is formed of an oxide superconducting member, and
the stabilization member is formed from a copper plating.

18. A superconducting coil comprising the high-temperature superconducting wire according to claim 14 having been wound to form the superconducting coil.

19. A superconducting coil comprising the high-temperature superconducting wire according to claim 15 having been wound to form the superconducting coil.

20. A superconducting coil comprising the high-temperature superconducting wire according to claim 16 having been wound to form the superconducting coil.

21. A superconducting coil comprising the high-temperature superconducting wire according to claim 17 having been wound to form the superconducting coil.
